(19) United States
(12) Patent Application Publication
(10) Pub. No.: US 2009/0198758 A1
(43) Pub. Date: Aug. 6, 2009

(54) METHOD FOR SIGN-EXTENSION IN A MULTI-PRECISION MULTIPLIER

(75) Inventors: Harry S. Barowski, Boeblingen (DE); Jeffrey Adam Butts, Hartsdale, NY (US); Silvia M. Mueller, Altdorf (DE); Tim Niggemeier, Laatzen (DE); Jochen Preiss, Boeblingen (DE)

Correspondence Address: CANTOR COLBURN LLP-IBM YORKTOWN, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/023,072

(22) Filed: Jan. 31, 2008

(51) Int. Cl. G06F 7/496

(52) U.S. Cl. 708/626

(57) ABSTRACT

A method for implementing sign extension within a multi-precision multiplier is described. The method includes receiving a first input within a multiplier core of the multiplier, receiving a second input within the multiplier core, and creating partial products in the multiplier core using the first and second inputs. The method also includes summing up the partial products in a partial product reduction tree in the multiplier core. The method also includes performing sign extension within the partial product reduction tree of the multiplier core by adding a value to a partial product of the partial product reduction tree. The method further includes computing an output from the partial product reduction tree, the output including a final product of the first and second inputs signed extended to a desired width.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

The present invention relates generally to the field of computer arithmetic, and more particularly to a mechanism of achieving sign extension of a multiplication result aligned in such a way as to not occupy the most significant bits of the actual multiplier implementation without a specific sign extension step either prior to or following the multiplication.

2. Description of Background

A multi-format multiplier may be defined as a circuit whose outputs contain the arithmetic product of two input signals, one or more arithmetic products of parts of the input signals, or the sum of one or more arithmetic products of parts of the input signals. The width of a multi-format multiplier is dictated by the widest data type that it is expected to handle. For data operands smaller than the full widths of one or both inputs, the significant result of the multiplication is contained in some bits that are a subset of all of the multiplier output bits. Depending on the particular alignment of the input data, the result may not be left-aligned; that is, the most significant bit of the result may not be in the most significant output bit of the multiplier. Depending on the needs of the subsequent hardware, signed results that are not left-aligned may require sign-extension.

In two's complement binary representation, sign extension of an M-bit number x to N-bits (N>M) ensures that the numeric value of the signed N-bit number matches that of the M-bit original number, in spite of the additional bits. For positive x, the N-bit two's complement sign extension is achieved by padding the left side (most significant side) of the M-bit number with N minus M zeros. For negative x, the M-bit number is padded on the left by N minus M ones. Equivalently, since the most significant bit of a two's complement number is the sign (0=positive, 1=negative), the leftmost bit may be simply copied to the left until the data is of the desired width.

Typically, sign extension is performed using this “bit copy method”, causing the electrical fanout of the original sign-bit to be large. This, in turn, impacts the speed of any operation requiring sign extension. Assuming the well-known Booth-encoded parallel multiplication technique is used, sign extension of the result is automatically achieved if the inputs are sign-extended. However, this merely pushes the delay associated with sign extension from after the multiplication to before the multiplication.

What is needed, therefore, is a method to perform the sign extension of multiplier results that are not left-aligned within the multiplier output bits within the multiplier's partial product reduction tree.

### SUMMARY OF THE INVENTION

The shortcomings of the prior art are overcome and additional advantages are provided through a method for implementing sign extension within a multi-precision multiplier. The method includes receiving a first input within a multiplier core of the multiplier, receiving a second input within the multiplier core, creating partial products using the first and second inputs, and summing up the partial products in a partial product reduction tree that is part of the multiplier core. The method also includes performing sign extension within the partial product reduction tree of the multiplier core by adding a value to a partial product. The method further includes computing an output from the partial product reduction tree, the output including a final product of the first and second inputs signed-extended to a desired width.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution which performs the sign extension of multiplier results not left-aligned within the multiplier's outputs within the partial product reduction tree itself. This is achieved by adding a specially chosen constant to the partial products by means of the bits to the left of the significant input data in the most significant partial product, which ensures that the result is sign-extended to the full width of the multiplier. Also, it eliminates the need for separate sign extension of either multiplier input or the multiplier result. Finally, it significantly reduces the fanout required on the input sign bit and allows the fanout to occur in parallel with the partial product generation step of the multiplier, effectively hiding the entire latency of the sign extension.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a state of the art implementation of a multi-format multiplier;

FIG. 2 illustrates another example of a state of the art implementation of the multi-format multiplier of FIG. 1; and

FIG. 3 illustrates an exemplary multiplier.

The detailed description explains the preferred embodiments of the invention, together with advantages and features, by way of example with reference to the drawings.

### DETAILED DESCRIPTION OF THE INVENTION

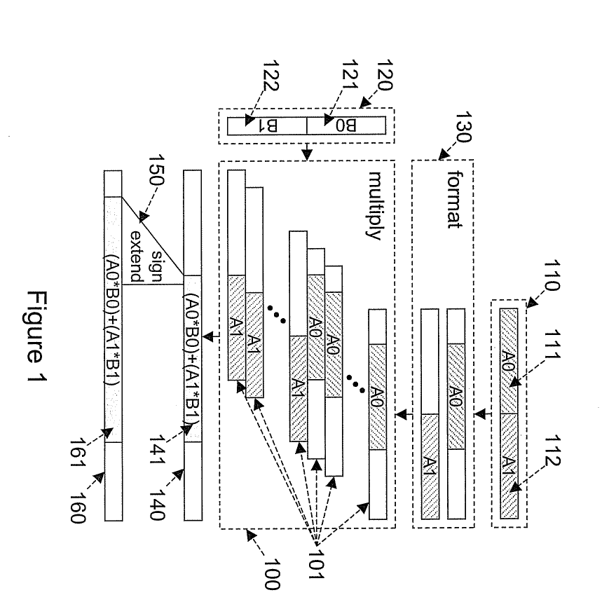

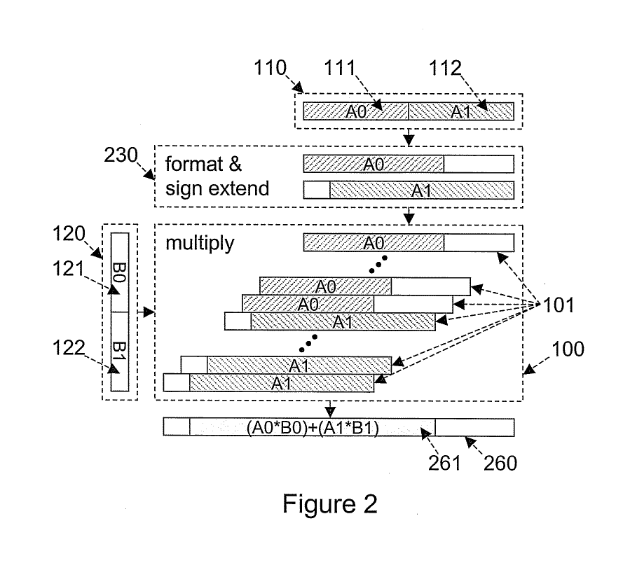

In accordance with exemplary embodiments, the invention allows for a sign extension of the result of a multiplication or a sum of a plurality of multiplications within the reduction tree of a multi-format multiplier. This removes the necessity of explicit sign extensions of the outputs (as shown in FIG. 1) or the inputs (as shown in FIG. 2) of the multiplier if the number of valid bits must be increased. The invention uses the properties of Booth multipliers in achieving the sign extension with very little overhead.

The multi-precision multiplier of the invention may be implemented in a fixed-point processor architecture operating on multiple operand widths, e.g., SEE (streaming single instruction multiple data extension) or VMX (vector media extension). The multi-precision multiplier may reside within one or more execution units of the pipelined architecture. Such fixed-point architectures may require the execution of either the multiplication of two 16-bit inputs with 32-bit result or the sum of up to four multiplications with 8-bit inputs and 32-bit result.

Turning now to the drawings in greater detail, it will be seen that in FIG. 1 there is a block diagram of a prior-art multi-format multiplier. The multi-format multiplier is able to compute the product of an input A (110), having a bit width M0, with an input B (120), having a bit width M1. The multi-format multiplier may also compute a plurality of products of subblocks of A and B in parallel, or the sum of a plurality of products of subblocks of A and B. This multi-format multiplier is capable of delivering a result (160) with up to M0+M1 valid bits by sign extending after the multiplication, where the multiplication is performed within a multiplier core 100. As an example, FIG. 1 shows the computation of R=(A0*B0)+(A1*B1) for subblocks A0 (111) and A1 (112) of A (110) of width N0=M0/2 and subblocks B0 (121) and B1 (122) of B (120) of width N1=M1/2.

Before accessing the multiplier core (100), the subblocks A0 (111) and A1 (112) are shifted in a formatting stage (130) in order to compute the correct partial products (101) for computing R=(A0*B0)+(A1*B1). The output (140) of the multiplier core (100) contains an intermediate value R with N0+N1+2 valid bits (141). The final result vector (160) is created by sign extending (150) the intermediate value of R (141), e.g., the most significant bits thereof, to M bits (161). The multiplier core 100 may be implemented as a Booth multiplier core using a Booth-encoding scheme.

FIG. 2 is a block diagram illustrating a prior-art variation of the multi-format multiplier of FIG. 1. This multiplier sign extends the inputs of the multiplication in order to deliver results with up to M0+M1 valid bits. In particular, the multiplier of FIG. 2 extends the subblocks A0 (111) and A1 (112), e.g., the most significant bits thereof, of the input A (110) during the shifting in a modified formatting stage (230). With these sign extended inputs, the multiplier core (100) is able to directly compute a final result (260) containing R with M valid bits (261).

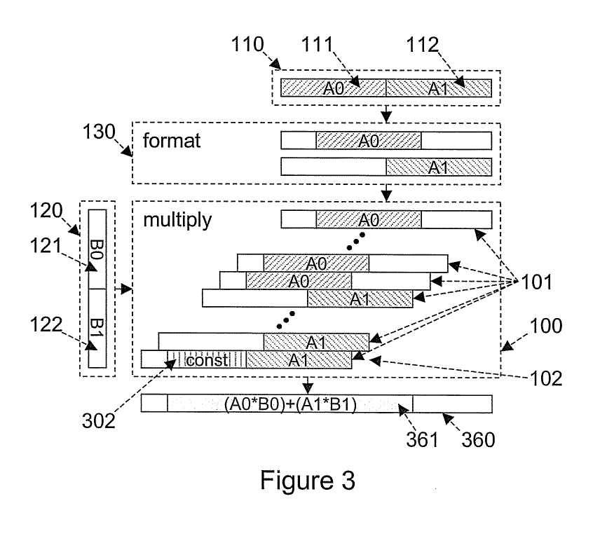

Turning now to FIG. 3, an exemplary multiplier will now be described. The embodiment of FIG. 3 does not require an explicit sign extension of the inputs or output of the multiplication. Instead, it includes logic for adding a value (also referred to herein as “constant”) within the multiplier core to perform the sign extension without additional processing delay as will now be described.

In particular, the exemplary embodiment of FIG. 3 adds a constant (302) within the Booth multiplier core (100) to perform the sign extension. With this additional constant, the multiplier core (100) is able to directly compute the final result (360) containing R with M valid bits (361). The constant 302 may be added as part of a partial product (102) and does not increase the number of terms that have to be summed up in the multiplier core (100). Furthermore, significant bits of the constant (302) are guaranteed not to overlap significant bits of the original partial product (102), allowing the constant to be included in the partial product with no arithmetic or logical operation beyond the selection of the appropriate bits from the original partial product (102) or the constant (302). For example, a 24-bit multiplier is capable of performing 8-bit multiply and multiply-sum operations, wherein a sign-extended 32-bit result is contained within the native 48-bit output of the multiplier. The partial products 101 are collectively summed in a partial product reduction tree.

The value of the constant (302) may be computed from the type of the multiplication (i.e., the number of multiplications to be summed up), the width of the multiplicands, and the number of valid bits needed in the output as described further herein. Since this information is usually known at an early stage, computing the constant usually does not increase the critical path. Note that the constant used in the multiplier is independent of any of the inputs (e.g., A and B). That is, computing the value of the constant does not require the actual data operands to be multiplied, a significant advantage over prior art implementations which require sign extension of the data inputs.

The multi-precision multiplier described in FIG. 3 is capable of computing multiplications for inputs having a plurality of bit widths or capable of computing the sum of a plurality of multiplications, wherein the multiplier can sign extend the result of multiplications having not the maximum bit width of the multiplier. The sign extension is done without explicitly sign extending the most significant bit of either the inputs or the result.

The number and alignment of the significant bits of the multiplier output varies according to the specific multiplication operation and input operand alignment, and the sign extension occurs from the variable position of the most significant product bit to a desired position within the multiplier output. This sign extension occurs by means of the inclusion of the operation-specific (but not data-specific) constant 302 in the partial-product reduction.

The exemplary embodiment uses a property of Booth multipliers. For inputs A(0:N0−1) and B(0:N1−1), a Booth multiplier does not compute R(0:N0+N1−1):=A(0:N0−1)*B(0:N1−1) but A(0:N0−1)*B(0:N1−1)+2^{N0+N1+2}. Thus, the result vector of a Booth multiplier is “100,R(0:N0+N1−1)” for R(0:N0+N1−1)>=0 (i.e., R(0)=0; equivalently, a positive result) and “011,R(0:N0+N1−1)” for R(0:N0+N1−1)>0 (i.e., R(0)=1; equivalently, a negative result). By adding the constant 2^{m}−2^{N0+N1+2} in the multiplier tree of the multiplier core (100), the result vector R′(0:M) is equal to “10 . . . 0,R(0:N0+N1−1)” for R(0)=0 and “01 . . . 1,R(0:N0+N1−1)” for R(0)=1, where the 0 (respectively 1) is repeated M−(N0+N1) times. Thus, the vector R′(1:M) equals the result R(0:N0+N1−1) sign extended to M bits, as desired.

As the multiplier of FIG. 3 adds a value to a partial product, there is no requirement for any additional partial product nor the extension of the width of any existing partial product. Also, none of the non-zero bits of the constant value overlap any input-derived bits within a partial product. This allows the constant to be included in the partial product with no arithmetic or logical operation beyond the selection of the appropriate bits from the original partial product (102) or the constant (302).

This modification, as described in FIG. 3, is also applicable to multi-format Booth multipliers computing the sum of a plurality of multiplications. To extend the sum of S products of inputs having widths N0[I] and N1[I] (with I in {0, . . . , S−1}) to M valid bits, it suffices to add the constant 2^{M}−2^{(N0[0])+(N1[0])+2}N+ . . . +2^{M}−2^{(N0[S-1])+(N1[S-1])+2} (mod 2^{M}).

The capabilities of the present invention can be implemented in software, firmware, hardware or some combination thereof.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for implementing a multi-precision multiplier, comprising:
receiving a first input within a multiplier core of the multiplier;
receiving a second input within the multiplier core;
creating partial products in the multiplier core using the first and second inputs, the multiplier core utilizing a Booth-encoding scheme;
summing up the partial products within a partial product reduction tree in the multiplier core;
performing sign extension within the partial product reduction tree of the multiplier core by adding a value to a partial product of the partial product reduction tree; and
computing an output from the partial product reduction tree, the output comprising a final product of the first and second inputs sign extended to a desired width.

2. The method of claim 1, wherein the value is independent of both the first and second inputs.

3. The method of claim 1, wherein the number and alignment of the significant bits of the output varies according to the multiplication operation and input operand alignment, and wherein the sign extension occurs from the variable position of the most significant product bit to a desired position within the output.

4. The method of claim 3, wherein the value is added within the partial product tree without an additional partial product and without a sign extension of any partial product in the partial product reduction tree, and wherein no non-zero bits of the value overlap any input-derived bits within one partial product.

5. The method of claim 4, wherein a 16- or more bit multiplier is capable of performing 8-bit multiply and multiply-sum operations, wherein a sign-extended 32-bit result is contained within the native 32- or more bit output of the multiplier.
